(19) United States
(12) Patent Application Publication
(10) Pub. No.: US 2008/0055486 A1
(43) Pub. Date: Mar. 6, 2008

(54) VIDEO TRANSMISSION APPARATUS AND CONNECTOR MODULE THEREOF

(75) Inventors: Chung-Ta Chin, Taipei (TW); Cheng-Jan Chi, Taipei (TW); Yi-Hsuan Huang, Taipei (TW); Wen-Cheng Ko, Taipei (TW); Jung-Rung Shr, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/846,540

(22) Filed: Aug. 29, 2007

(30) Foreign Application Priority Data
Aug. 30, 2006 (TW) 95131990

(51) Int. Cl. H04N 5/38; H01R 13/70

(52) U.S. Cl. 348/723; 439/620.21; 348/E05.093

(57) ABSTRACT

A video transmission apparatus and the connector module thereof are provided. The connector module includes a first resistor and a second resistor. The first resistor is coupled between a voltage source and a transmission pin. The second resistor is coupled between a ground terminal and a connector. When the transmission pin is in a floating state, the transmission pin outputs a floating voltage. And when the connector is coupled to the transmission pin, the transmission pin outputs a connection voltage. According to the DC voltage output by the transmission pin, the connector module judges the coupling state between the connector and the transmission pin.

### CROSS-REFERENCE TO RELATED APPLICATION

This application claims the priority benefit of Taiwan application serial no. 95131990, filed on Aug. 30, 2006. All disclosure of the Taiwan application is incorporated herein by reference.

### BACKGROUND OF THE INVENTION

1. Field of the Invention

The present invention relates to a video transmission apparatus. More particularly, the present invention relates to a video transmission apparatus and the video connector module thereof capable of identifying the coupling state between a connector and a plurality of transmission pins.

2. Description of Related Art

Common video output apparatus (for example, digital video disc player or DVD player) normally has a plurality of sockets (transmission pins) to satisfy a number of video transmission format, for example, National Television System Committee (NTSC) or Phase Alternation Line (PAL). Therefore, when video signals with different specifications are used, the users generally have to set up the transmission mode on their own so that the video output apparatus can correctly output a video signal compatible to the specification of a video display apparatus. If the setting is incorrect, the correct video signal may not be displayed.

However, the correct setting of the transmission mode of the video output apparatus by common users according to the video transmission format and the type of video display apparatus is difficult. Moreover, the required setting significantly lowers the convenience of using the video output apparatus.

### SUMMARY OF THE INVENTION

Accordingly, at least one objective of the present invention is to provide a video transmission apparatus that utilizes resistive voltage division principals to judge which one of the transmission pins actually used when the video display apparatus is connected to a video output apparatus, and subsequently, decide on a compatible video transmission format between the video output apparatus and the video display apparatus so as to output a specification compatible video signal to the video display apparatus.

At least another objective of the present invention is to provide a video connector module for connecting a video output apparatus with a video display apparatus. There are different resistors are disposed on the video output apparatus and the video display apparatus respectively, so as to judge the coupling states between the transmission pins and the connector with resistive voltage division principles. Hence, a video signal having a compatible specification is switched to the video display apparatus.

To achieve the above-mentioned or other objectives, the present invention provides a video transmission apparatus suitable for identifying the coupling states between a connector and a plurality of transmission pins. The transmission pin Pᵢ represents the i^{th} transmission pin, where i is a positive integer. The video transmission apparatus includes a switching unit, a plurality of isolating capacitors, a plurality of first resistors and a second resistor. The switching unit has a plurality of output terminals, wherein the output terminal Oᵢ represents the i^{th} output terminal. The output terminal Oᵢ corresponds to the transmission pin Pi, and the switching unit is used for switching the corresponding video signal to one of the transmission pins. The isolating capacitors are respectively coupled between the output terminals and the transmission pins for isolating DC voltages. The first resistors are respectively coupled between a voltage source and the foregoing transmission pins, wherein the resistor Rᵢ represents the i^{th} first resistor and coupled between the voltage source and the transmission pin Pᵢ. The second resistor is coupled between a ground terminal and the connector.

When the transmission pin Pᵢ is in a floating state, the transmission pin Pᵢ outputs a floating voltage. And when the connector is coupled to the transmission pin Pᵢ, the transmission pin Pᵢ outputs a connection voltage. According to the DC voltage on the transmission pin Pᵢ, the transmission apparatus judges the coupling state between the connector and the transmission pin Pᵢ. When the transmission pin Pᵢ outputs the connection voltage, the foregoing switching unit switches the corresponding video signal to the transmission pin Pᵢ.

The present invention also provides a connector module suitable for identifying the coupling states between a connector and a plurality of transmission pins. The transmission pin Pᵢ represents the i^{th} transmission pin, wherein i is a positive integer. The connector module includes a plurality of first resistors and a second resistor. The first resistors are respectively coupled between a voltage source and the transmission pins. The resistor Rᵢ represents the i^{th} first resistor. The resistor Rᵢ is coupled between the voltage source and the transmission pin Pᵢ, and the second resistor is coupled between a ground terminal and the connector.

When the transmission pin Pᵢ is in a floating state, the transmission pin Pᵢ outputs a floating voltage. And when the connector is coupled to the transmission pin Pᵢ, the transmission pin Pᵢ outputs a connection voltage. The connector module judges the coupling state between the connector and the transmission pin Pᵢ, according to the variation of the DC voltage on the transmission pin Pᵢ.

The present invention also provides another connector module suitable for identifying the coupling state between a connector and a transmission pin. The connector module includes a first resistor and a second resistor. The first resistor is coupled between a voltage source and the transmission pin, and the second resistor is coupled between a ground terminal and a connector.

When the transmission pin is in a floating state, the transmission pin outputs a floating voltage. And when the connector is coupled to the transmission pin, the transmission pin outputs a connection voltage. According to the variation in DC voltage on the transmission pin, the transmission apparatus judges the coupling state between the connector and the transmission pin.

The present invention utilizes the resistive voltage division principle to automatically detect which one of the transmission pins actually used between the video display apparatus and the video output apparatus, and automatically switch to output a video signal in a compatible format so that the video output apparatus is more convenient to use. Meanwhile, the present invention also utilizes a capacitor to isolate DC voltage so that the output quality of the video signal is maintained after passing through the video transmission apparatus.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a connector module according to one embodiment of the present invention.

FIG. 2 is a schematic diagram of another connector module according to one embodiment of the present invention.

FIG. 3 is a schematic diagram of a video transmission apparatus according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

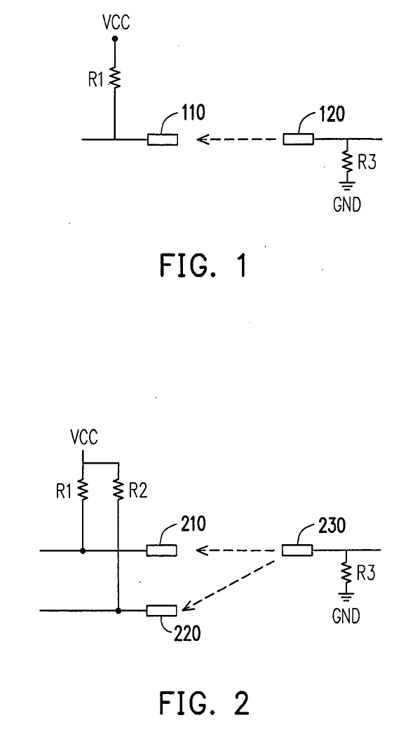

FIG. 1 is a schematic diagram of a connector module according to one embodiment of the present invention. The resistor R1 is coupled between a voltage source VCC and a transmission pin 110, and a resistor R3 is coupled between a connector 120 and a ground terminal GND. The ratio of the resistance between the resistor R1 and the resistor R3 is greater than a preset value. Hence, when the connector 120 is coupled to the transmission pin 110, a logic low voltage is generated on the transmission pin 110 because of the resistive voltage division between resistor R1 and resistor R3. In the present embodiment, the resistance of the resistor R1 is 100 KΩ and the resistance of the resistor R3 is 750Ω, for example.

When the transmission pin 110 is in a floating state, the transmission pin 110 outputs a floating voltage. Because the resistor R1 will not generate a voltage difference, the floating voltage at the transmission pin 100 is substantially logic high. When the connector 120 is coupled to the transmission pin 100, the transmission pin 110 outputs a connection voltage. The connection voltage depends on the resistance ratio between the resistor R1 and the resistor R3. In the present embodiment, the transmission pin 100 obviously outputs an logic low voltage. By using the DC voltage level outputted from the transmission pin 110 (the output of transmission pin 110 is logic high in the floating state and logic low when the transmission pin 110 is coupled to the connector 120), the coupling state between the transmission pin 110 and the connector 120 can be judged.

In the present embodiment, the transmission pin 110 can be disposed on a video output apparatus (for example, a DVD player) and the connector 120 can be disposed on a video display apparatus (for example, a television). When the television is connected to the DVD player through the connector 120, the DVD player identifies whether the connecting action between the connector 120 of the television and the transmission pin 110 is completed via the connection voltage outputted by the transmission pin 110, so as to output a specification compatible video signal to the television. Conversely, the connector 120 can be disposed on the video output apparatus and the transmission pin 110 can be disposed on the video display apparatus, and the coupling relationship between the transmission pin 110 and the connector 120 can be similarly detected. Since those skilled in the art may easily deduce the techniques involved, a detailed description is omitted.

In general, video output apparatus have a number of video transmission specifications. Furthermore, each transmission specification transmits signals through a different transmission pin 110 or a socket. The embodiment of the present invention is also suitable for a transmission interface having a plurality of transmission specifications to identify which transmission specification is selected. FIG. 2 is a schematic diagram of another connector module according to an embodiment of the present invention. In the present embodiment, two sets of transmission pins are used in the illustration. The transmission pins 210 and 220 may transmit image signals belonging to two different specifications. The resistors R1 and R2 are coupled between a voltage source VCC and the transmission pins 210 and 220 respectively. The resistor R3 is coupled between the connector 230 and a ground terminal GND. The resistance of the resistor R1 and the resistor R2 in the present embodiment may be identical. The resistance ratio between the resistor R1 or R2 and the resistor R3 is greater than a preset value, so as to when the connector 230 is coupled to the transmission pin 210 or the transmission pin 220, the corresponding transmission pin 210 or 220 outputs a connection voltage with logic low. Since the techniques involved in the present embodiment are similar to the embodiment already described with reference to FIG. 1, a detailed description is omitted.

The transmission pins 210 and 220 are responsible for transmitting video signals of different specifications (for example, NTSC and PAL) respectively. The connector module determines whether the connector 230 is coupled to the transmission pin 210 or 220 according to the output voltage level of the transmission pins 210 and 220. When the connector 230 is coupled to the transmission pin 210, the transmission pin 210 outputs a connection voltage with logic low, while the transmission pin 220 is maintained in a floating state and outputs a floating voltage with logic high, and vice versa. Hence, the connector module is able to know which transmission pin is used to couple between the video output apparatus and the video display apparatus and outputs a specification compatible video signal accordingly.

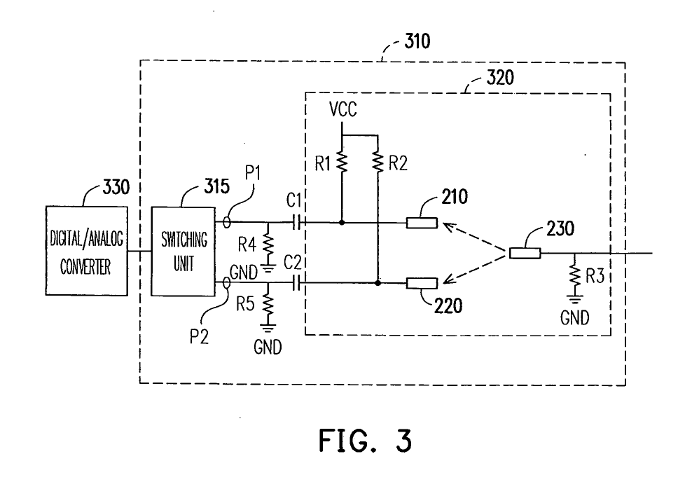

FIG. 3 is a schematic diagram of a video transmission apparatus according to another embodiment of the present invention. The video transmission apparatus 310 includes a switch unit 315 and a connector module 320. Since the connector module 320 is similar to the one described in FIG. 2, a detailed description is omitted. The switch unit 315 includes output terminals P1 and P2 coupled to the transmission pins 210 and 220 through the capacitors C1 and C2 respectively. Furthermore, another terminal of the switch unit 315 is coupled to a digital/analog converter 330. The resistors R4 and R5 are coupled between the output terminals P1, P2 and a ground terminal GND. The output terminals P1 and P2 are responsible for outputting video signals of different specifications respectively. The capacitors C1 and C2 are responsible for isolating DC voltage outputted by the transmission pins 210 and 220 respectively so that the DC voltage is prevented from affecting the video signals outputted by the output terminals P1 and P2. In the floating state, the transmission pins 210 and 220 output a floating voltage whose DC voltage level can be regarded as a logic high level.

When the connector 230 is coupled to one of the transmission pins 210 and 220, the DC voltage of the corresponding transmission pin 210 or 220 is converted to logic low. When the DC voltage of the connection voltage outputted by the transmission pin 210 isis logic low, this implies that the connector 230 is coupled to the transmission pin 210. Then, the switch unit 315 outputs a video signal matching the specification through the transmission pin 210 to the connector 230. On the contrary, if the connection voltage outputted by the transmission pin 220 is logic low, the switch unit 315 outputs a video signal matching the video specification of the transmission pin 220 to the connector 230 through the transmission pin 220. In FIG. 3, a video transmission apparatus having only two transmission pins 210, 220 is used as an example showing the main techniques involved in the present invention. However, the present invention is not limited there-to, it can also be applied to a video transmission apparatus with a plurality of transmission pins.

In summary, when the connector is coupled to a selected transmission pin, the selected transmission pin will generate a change in potential as a result of resistive voltage division. Thus, through the change in potential in the transmission pin, the transmission pin actually in use can be determined and the corresponding video signal is outputted for displaying the video signal correctly. Similarly, the embodiment of the present invention is also suitable for a video transmission module having a plurality of transmission pins and supporting a plurality of video signal specifications. Using the techniques described in the foregoing embodiments with reference to FIGS. 1 through 3, by disposing corresponding resistors (for example, the i^{th} resistor R1 is coupled between the voltage source and the i^{th} transmission pin Pᵢ, where i is a positive integer) on the transmission pin and the connector, the transmission pin actually in use and the corresponding video signal specification can be detected through the logic potential on the transmission pin. The techniques involved in using a plurality of transmission pins are very similar to the ones mentioned in the foregoing embodiments. Since those skilled in the art may easily deduce the techniques according to the disclosure in the present invention, a detailed description is omitted.

Because most video output apparatus use different transmission pins or sockets to distinguish between video signals having different specifications, the detection method in the present invention can be utilized to automatically detect the transmission pin or socket used by the user. Thus, the specification of the video display apparatus is known and a video signal with a suitable specification is output from the correct transmission pin or socket. As a result, the convenience of using the video output apparatus is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A video transmission apparatus for identifying a coupling state between a connector and a plurality of transmission pins, a transmission pin Pᵢ representing an i^{th} transmission pin, wherein i is a positive integer, the video transmission apparatus comprising:
a switching unit having a plurality of output terminals for switching a video signal to one of the transmission pins, wherein an output terminal Oᵢ corresponds to the transmission pin Pi and represents an i^{th} output terminal;
a plurality of capacitors respectively coupled between the output terminals and the transmission pins for isolating DC voltage;
a plurality of first resistor, respectively coupled between a voltage source and the transmission pins, wherein a resistor Rᵢ coupled between the voltage source and the transmission pin Pᵢ and represents an i^{th} first resistors; and
a second resistor, coupled between a ground terminal and the connector;
wherein, when the transmission pin Pᵢ is in a floating state, the transmission pin Pᵢ outputs a floating voltage, and when the connector is coupled to the transmission pin Pᵢ, the transmission pin Pᵢ outputs a connection voltage, and the video transmission apparatus judges the coupling state between the connector and the transmission pin Pᵢ according to the variation of the DC voltage, and when the transmission pin Pᵢ outputs the connection voltage, the switching unit switches a video signal to the transmission pin Pᵢ.

2. The video transmission apparatus of claim 1, wherein the floating voltage is logic high.

3. The video transmission apparatus of claim 1, wherein a ratio between a resistance of first resistor and that of the second resistor is greater than a preset value so that the connection voltage is logic low when the connector is coupled to the transmission pin Pᵢ.

4. The video transmission apparatus of claim 1, wherein further comprising a plurality of third resistors respectively coupled between the output terminals and the ground terminal.

5. The video transmission apparatus of claim 1, wherein the connector is disposed on a display apparatus.

6. The video transmission apparatus of claim 1, wherein the transmission pins are disposed on a video output apparatus.

7. The video transmission apparatus of claim 1, wherein the connector is disposed on a video output apparatus.

8. The video transmission apparatus of claim 1, wherein the transmission pins are disposed on a display apparatus.

9. A connector module for identifying a coupling state between a connector and a plurality of transmission pins, wherein a transmission pin Pᵢ represents the i^{th} transmission pin, and wherein i is a positive integer, the connector module comprising:
a plurality of first resistors, respectively coupled between a voltage source and a plurality of transmission pins, wherein a resistor Rᵢ represents the i^{th} first resistors and coupled between the voltage source and the transmission pin Pᵢ; and
a second resistor, coupled between a ground terminal and the connector;
wherein, when the transmission pin Pᵢ is in a floating state, the transmission pin Pᵢ outputs a floating voltage, and when the connector is coupled to the transmission pin Pᵢ, the transmission pin Pᵢ outputs a connection voltage, and the connector judges the coupling state between the connector and the transmission pin Pᵢ according to the variation of the DC voltage.

10. The connector module of claim 9, wherein the floating voltage is logic high.

11. The connector module of claim 9, wherein the ratio between a resistance of first resistor and that of the second resistor is greater than a preset value so that the connection voltage is logic low when the connector is coupled to the transmission pin Pᵢ.

12. The connector module of claim 9, wherein the connector is disposed on a display apparatus.

13. The connector module of claim 9, wherein the transmission pins are disposed on a video output apparatus.

14. The connector module of claim 9, wherein the connector is disposed on a video output apparatus.

15. The connector module of claim 9, wherein the transmission pins are disposed on a display apparatus.

16. A connector module for identifying a coupling state between a connector and a transmission pin, the connector module comprising:
a first resistor, coupled between a voltage source and the transmission pin; and
a second resistor, coupled between a ground terminal and the connector;
wherein, when the transmission pin Pᵢ is in a floating state, the transmission pin outputs a floating voltage, and when the connector is coupled to the transmission pin, the transmission pin outputs a connection voltage, and the connector module judges the coupling state between the connector and the transmission pin according to the variation of the DC voltage.

17. The connector module of claim 16, wherein the floating voltage is logic high.

18. The connector module of claim 16, wherein the ratio between a resistance of first resistor and that of the second resistor is greater than a preset value so that the connection voltage is logic low when the connector is coupled to the transmission pin.

19. The connector module of claim 16, wherein the connector is disposed on a display apparatus.

20. The connector module of claim 16, wherein the transmission pin is disposed on a video output apparatus.

21. The connector module of claim 16, wherein the connector is disposed on a video output apparatus.

22. The connector module of claim 16, wherein the transmission pin is disposed on a display apparatus.
